(19) United States
(12) Patent Application Publication
(10) Pub. No.: US 2025/0058291 A1
(43) Pub. Date: Feb. 20, 2025

(54) APPARATUS AND METHOD FOR CONTROLLING VISCOSITY OF SLURRY

(71) Applicant: SAMSUNG SDI CO., LTD., Yongin-si (KR)

(72) Inventors: Bo Ra KIM, Suwon-si (KR); Yong Jin KIM, Suwon-si (KR); Jake KIM, Suwon-si (KR); Tae Sung AHN, Suwon-si (KR); Hee Chan JUNG, Suwon-si (KR); Yong Jun HWANG, Suwon-si (KR); Jee Hoon HAN, Suwon-si (KR); Jong Man KIM, Suwon-si (KR); Gi Heon KIM, Suwon-si (KR)

(21) Appl. No.: 18/533,664

(22) Filed: Dec. 8, 2023

(30) Foreign Application Priority Data
Aug. 14, 2023 (KR) 10-2023-0106081

(51) Int. Cl. B01F 35/221; B01F 35/22

(52) U.S. Cl. CPC B01F 35/221; B01F 35/2201; B01F 2215/0495

(57) ABSTRACT

An apparatus for controlling viscosity of a slurry includes a mixing module mixing raw materials for a secondary battery, and a processor performing machine learning for prediction of viscosity of the slurry, predicting viscosity of the slurry in real time during a mixing process through machine learning, and adjusting conditions of the mixing process performed by the mixing module such that a predictive viscosity of the slurry meets a target viscosity.

### CROSS-REFERENCE TO RELATED APPLICATIONS

This application claims priority from and the benefit of Korean Patent Application No. 10-2023-0106081, filed on Aug. 14, 2023, which is hereby incorporated by reference for all purposes as if set forth herein.

### BACKGROUND

### 1. Field

Embodiments relate to an apparatus and method for controlling viscosity of a slurry for electrode active materials.

### 2. Description of the Related Art

In general, a process of manufacturing a secondary battery starts with mixing of raw materials.

Viscosity of the mixed slurry can indicate a mixed state of the raw materials.

Specifically, in the mixing process, an active material, a conductive material, and a binder are mixed with a solvent to form a slurry which in turn is supplied to a subsequent coating process.

### SUMMARY

Embodiments are directed to an apparatus for controlling viscosity of a slurry, having a mixing module mixing raw materials for a secondary battery, and a processor performing machine learning for prediction of viscosity of the slurry, predicting viscosity of the slurry in real time during a mixing process through machine learning, and adjusting conditions of the mixing process performed by the mixing module such that a predictive viscosity of the slurry meets a target viscosity.

In embodiments, the processor extracts at least one mixing process datum highly correlated with viscosity of the slurry from multiple mixing process data through machine learning and performs prediction of viscosity of the slurry based on the at least one mixing process datum.

In embodiments, the processor generates a first model through training with N mixing process data and N final actual viscosity data using a predetermined algorithm, the first model being a model for extraction of mixing process data highly correlated with a final viscosity of the slurry and prediction of viscosity of the slurry.

In embodiments, the processor identifies at least one topmost factor highly correlated with a final actual viscosity using a first model, calculates multiple top factor data through preprocessing of the identified topmost factor for each mixing step, and generates a second model through training with the multiple top factor data calculated for each mixing step and final actual viscosity data using a predetermined algorithm, the second model being a model for extraction of mixing process data highly correlated with a final viscosity of the slurry and prediction of viscosity of the slurry.

In embodiments, the processor checks prediction accuracy of the second model, and if the prediction accuracy of the second model is greater than or equal to a predetermined rate, the processor retrains or updates the second model each time new data is generated and, if the prediction accuracy of the second model is less than the predetermined rate, the processor changes the algorithm.

In embodiments, the processor controls the mixing module by calculating a final predictive viscosity by inputting mixing process data to a second model upon start of mixing, calculating a new final predictive viscosity by changing settings of mixing process data identified to be highly correlated with a final actual viscosity of the slurry from a first model and the second model and inputting the mixing process data changed due to change of the settings to the second model, if the final predictive viscosity does not meet the target viscosity, and calculating settings of mixing process factors ensuring that the final predictive viscosity meets the target viscosity by repeating a procedure of changing settings of mixing process data and calculating a final predictive viscosity until the final predictive viscosity meets the target viscosity.

Embodiments are also directed to a method for controlling viscosity of a slurry, including controlling, by a processor, a mixing module to mix raw materials for a secondary battery, performing, by the processer, machine learning for prediction of viscosity of the slurry and predicting viscosity of the slurry in real time during a mixing process through machine learning, and adjusting, by the processor, conditions of the mixing process performed by the mixing module such that a predictive viscosity of the slurry meets a target viscosity.

In embodiments, in predicting viscosity of the slurry in real time, the processor extracts at least one mixing process datum highly correlated with viscosity of the slurry from multiple mixing process data through machine learning and performs prediction of viscosity of the slurry based on the at least one mixing process datum.

In embodiments, in order to predict viscosity of the slurry in real time, the processor generates a first model through training with N mixing process data and N final actual viscosity data using a predetermined algorithm, the first model being a model for extraction of mixing process data highly correlated with a final viscosity of the slurry and prediction of viscosity of the slurry.

In embodiments, in order to predict viscosity of the slurry in real time, the processor identifies at least one topmost factor highly correlated with a final actual viscosity using a first model, calculates multiple top factor data through preprocessing of the identified topmost factor for each mixing step, and generates a second model through training with the multiple top factor data calculated for each mixing step and final actual viscosity data using a predetermined algorithm, the second model being a model for extraction of mixing process data highly correlated with a final viscosity of the slurry and prediction of viscosity of the slurry.

In embodiments, the processor checks prediction accuracy of the second model, and, if the prediction accuracy of the second model is greater than or equal to a predetermined rate, the processor retrains or updates the second model each time new data is generated, and if the prediction accuracy of the second model is less than the predetermined rate, the processor changes the algorithm.

In embodiments, in the step of adjusting conditions of the mixing process performed by the mixing module, the processor controls the mixing module by calculating a final predictive viscosity by inputting mixing process data to a second model upon start of mixing, calculating a new final predictive viscosity by changing settings of mixing process data identified to be highly correlated with a final actual viscosity of the slurry from a first model and the second model and inputting the mixing process data changed due to change of the settings back to the second model, if the final predictive viscosity does not meet the target viscosity, and calculating settings of mixing process factors ensuring that the final predictive viscosity meets the target viscosity by repeating a procedure of changing settings of mixing process data and calculating a final predictive viscosity until the final predictive viscosity meets the target viscosity.

The present embodiments have been conceived to solve such problems in the art and to provide an apparatus and method for controlling viscosity of a slurry, which can predict a final viscosity of the slurry in real time during a mixing process based on mixing process data highly correlated with the final viscosity and can control the viscosity of the slurry by changing conditions of the mixing process if the viscosity of the slurry is predicted to be out of specification.

The apparatus and method for controlling viscosity of a slurry according to the present invention can achieve slurry viscosity meeting desired specifications through real-time prediction of viscosity of a slurry while reducing errors in measurement of viscosity of the slurry and eliminating the necessity of additional manual work and additional resource consumption.

### BRIEF DESCRIPTION OF THE DRAWINGS

Features will become apparent to those of skill in the art by describing in detail exemplary embodiments with reference to the attached drawings, in which:

FIG. 1 is a schematic block diagram of an apparatus for controlling viscosity of a slurry according to an embodiment;

FIG. 2 is a flow diagram of a method for generating a model for prediction of viscosity of a slurry according to an embodiment;

FIG. 3 is a flow diagram of a method for changing mixing process conditions based on prediction of viscosity of a slurry according to an embodiment;

FIG. 4 illustrates mixing process factors according to an embodiment;

FIG. 5 illustrates prediction accuracy of a first model and a second model with respect to viscosity of a slurry according to an embodiment; and

FIG. 6 illustrates test results of factors identified to be highly correlated with a final actual viscosity (Y) from a first model and a second model according to an embodiment.

### DETAILED DESCRIPTION

Herein, some embodiments of the present disclosure will be described, in further detail, with reference to the accompanying drawings. The terms or words used in this specification and claims should not be construed as being limited to the usual or dictionary meaning and should be interpreted to have a meaning and concept consistent with the technical idea of the present disclosure based and on the principle that the inventor can be their own lexicographer to appropriately define the concept of the term to explain their invention in the best way.

The embodiments described in this specification and the configurations shown in the drawings represent some of the embodiments of the present disclosure and do not necessarily represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. When a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or similar elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to the another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

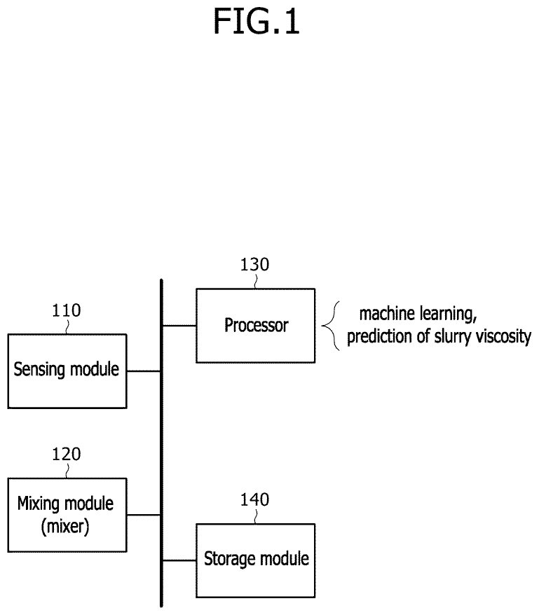

FIG. 1 is a schematic block diagram of an apparatus for controlling viscosity of a slurry according to an embodiment.

Referring to FIG. 1, the apparatus for controlling viscosity of a slurry may include a sensing module 110, a mixing module 120 (e.g., a P/D mixer), a processor 130, and a storage module 140.

The sensing module 110 may detect information about operation of the mixing module 120 (e.g., a P/D mixer) or information about a status of a mixing process. The sensing module 110 may include multiple sensors, e.g., a temperature sensor, an infrared sensor, a camera sensor, a current detection sensor, as well as any other relevant sensors, adapted to detect information about operation of the mixing module 120 or information about the status of a mixing process.

The processor 130 may perform machine learning, i.e., deep learning, for prediction of the viscosity of the slurry and may predict the viscosity of the slurry in real time during a mixing process through machine learning, i.e., deep learning.

The mixing process may cause changes in size of solids in the slurry and thus changes in viscosity of the slurry depending on the surface area fraction of the solids dispersed in the slurry. In order to perform dispersion of the solids, an appropriate blade, e.g., a planetary blade, a Despa blade, etc., may be rotated at a predetermined power or rate. Depending on conditions of the mixing process, the degree of dispersion of the solids may vary and may cause variations in the viscosity of the slurry. Rheological studies have also shown that there is a correlation between power required to rotate the blade and viscosity of the slurry. As such, viscosity of the slurry may be estimated by working backwards from the conditions of the mixing process performed by the blade.

The processor 130 may perform prediction of viscosity of the slurry (or develop a model for prediction of viscosity of the slurry) by extracting mixing process data, i.e., a mixing process factor, that may be highly correlated with viscosity of the slurry from multiple mixing process data, i.e., multiple mixing process factors, through machine learning.

The processor 130 may extract mixing process data, i.e., mixing process factor, highly correlated with a final viscosity of the slurry from multiple mixing process data, i.e., multiple mixing process factors, and may predict the final viscosity of the slurry based on the extracted mixing process data, i.e., mixing process factor.

The storage module 140 may store the multiple mixing process data, i.e., mixing process factors such as power of a mixer, rpm of the blade, and operating time of the blade.

The storage module 140 may store a model for prediction of viscosity of the slurry.

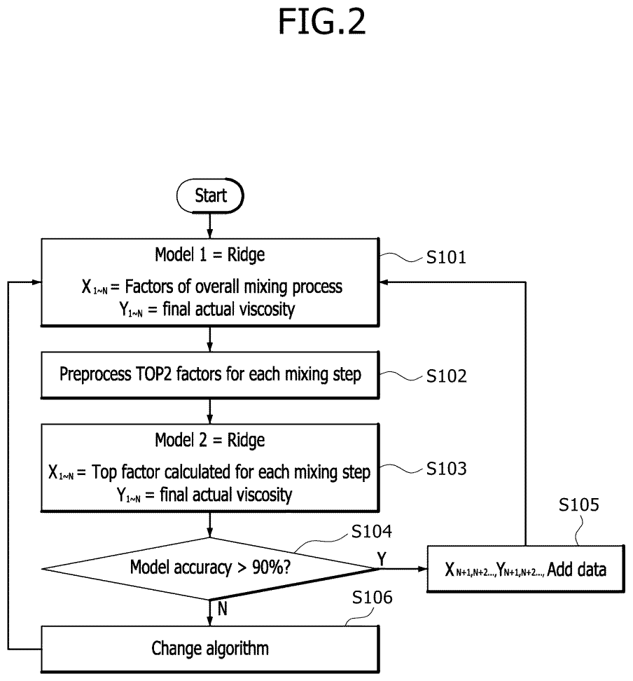

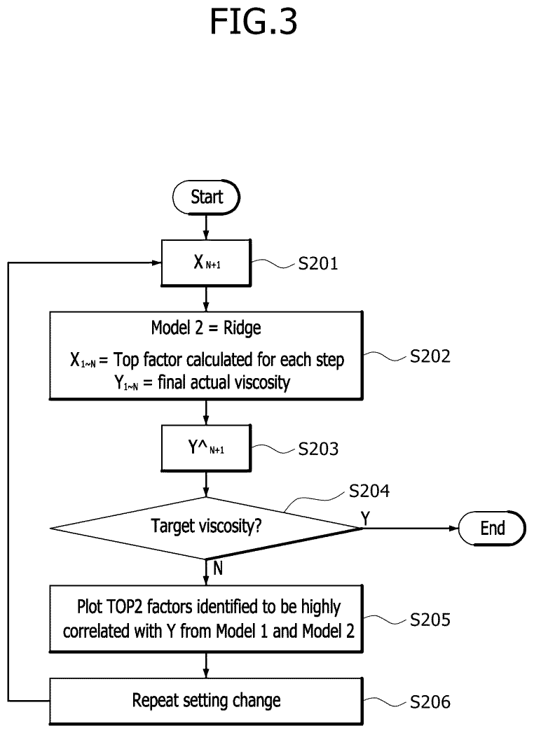

A method for controlling viscosity of a slurry to meet specifications by changing mixing process conditions based on prediction of viscosity of the slurry will be described with reference to FIG. 2 and FIG. 3.

FIG. 2 is a flow diagram of a method for generating a model for prediction of viscosity of a slurry according to an embodiment.

Referring to FIG. 2, the processor 130 generates a first model Model 1, e.g., a model for extraction of mixing process data highly correlated with a final viscosity of the slurry and prediction of viscosity of the slurry, through training with N mixing process data, i.e., mixing process factors, X (X_{1 to N}) and N final actual viscosity data Y (Y_{1 to N}) using a predetermined algorithm, e.g., Ridge algorithm (S101).

Each of the N mixing process data, i.e., mixing process factors, X (X_{1 to N}) (that is, mixing process factors) may be represented by an average value, and a shear rate for acquiring the N final actual viscosity data Y (Y_{1 to N}) may be set to a predetermined value, e.g., shear rate: 10.

The processor 130 identifies at least one topmost factor TOP2 highly correlated with a final actual viscosity Y using the first model Model 1 and calculates multiple, e.g., 46, top factors through preprocessing of the identified topmost factor TOP2 for each mixing step (S102).

The processor 130 generates a second model Model 2, e.g., a model for extraction of mixing process data highly correlated with the final viscosity of the slurry and prediction of viscosity of the slurry, through training with the multiple, e.g., 46, top factor data X (X_{1 to N}) calculated for each mixing step and the final actual viscosity data Y (Y_{1 to N}) using a predetermined algorithm, e.g., Ridge algorithm) (S103).

The processor 130 checks prediction accuracy of the second model Model 2 (S104). If the prediction accuracy of the second model is greater than or equal to a predetermined rate (for example, 90%) (or if the prediction accuracy of the second model is greater than the predetermined rate), the processor 130 retrains or updates the second model with new data (X_{N+1, N+2}, . . . , Y_{N+1, N+2} . . . ) generated after modeling (S105). This procedure may be repeatedly performed whenever new data is generated.

If the prediction accuracy of the second model Model 2 is less than the predetermined rate (for example, 90%), i.e., if No is selected in step (S104), the processor 130 may change the algorithm, e.g., may change Ridge algorithm (a linear algorithm) to another algorithm (a non-linear algorithm) (S106).

FIG. 3 is a flow diagram of a method for changing mixing process conditions based on prediction of viscosity of a slurry according to an embodiment.

Referring to FIG. 3, if N+1^{st} data (X_{N+1}) is input to the second model Model 2 upon start of mixing (S201), the processor 130 uses the second model Model 2 (S202) to calculate a final predictive viscosity Y\hat{ }_{N+1} (S203).

The processor 130 checks whether the calculated final predictive viscosity Y\hat{ }_{N+1} is equal to a target viscosity, i.e., a target slurry viscosity, (S204). If the calculated final predictive viscosity Y\hat{ }_{N+1} is equal to the target viscosity, i.e., if Yes is selected in step (S204), the processor 130 terminates a mixing process condition changing process.

If the calculated final predictive viscosity Y\hat{ }_{N+1} is not equal to the target viscosity (that is, the target slurry viscosity), i.e., if No is selected in step (S204), the processor 130 changes settings of mixing process data, i.e., mixing process factor, identified to be highly correlated with the final actual viscosity Y from the first model and the second model, i.e., changes mixing process conditions (S206) and inputs the mixing process data X_{N+1}, which is changed due to change of the settings, to the second model Model 2 to calculate a new final predictive viscosity Y\hat{ }_{N+1}.

This procedure (that is, a procedure of changing settings of mixing process factors (that is, changing mixing process conditions) and calculating a final predictive viscosity for achievement of a target viscosity) is repeated until the final predictive viscosity Y\hat{ }_{N+1} meets the target viscosity (S207).

In this way, the processor may control the mixing module 120 by calculating settings of mixing process factors (mixing process conditions) ensuring that the final predictive viscosity (Y\hat{ }_{N+1}) meets the target viscosity.

As described above, the apparatus and method according to embodiments may provide real-time prediction of a final viscosity of a slurry during a mixing process based on mixing process data highly correlated with the final viscosity of the slurry and may control viscosity of the slurry to a target viscosity by changing mixing process conditions, i.e., changing settings of mixing process factors, if viscosity of the slurry is predicted to be out of specification.

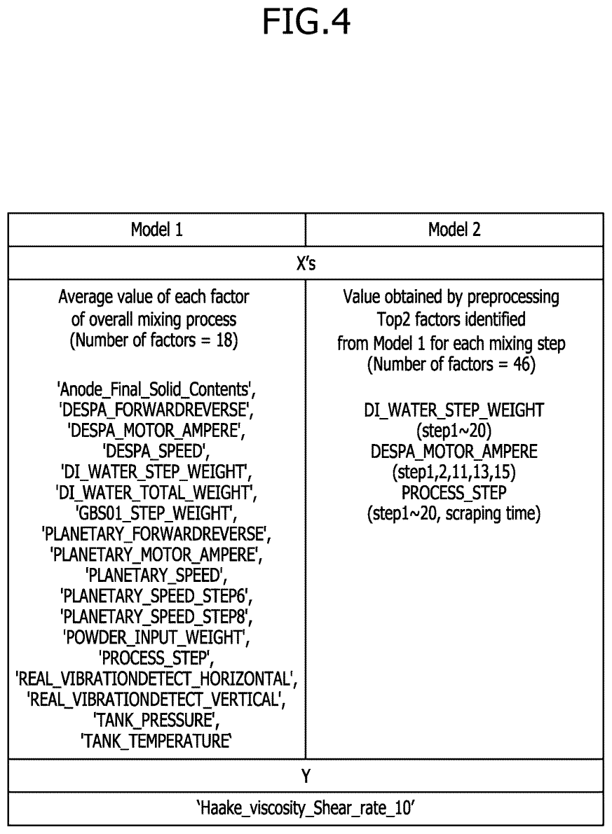

FIG. 4 illustrates mixing process factors according to an embodiment.

Referring to FIG. 4, a first model according to this embodiment determines correlation between viscosity of a slurry and 18 factors and a second model according to this embodiment determines correlation between viscosity of the slurry and 46 factors. Although a linear algorithm, e.g., Ridge algorithm, was used to generate the first model and the second model, it will be understood that the present invention is not limited thereto and various other algorithms may be used.

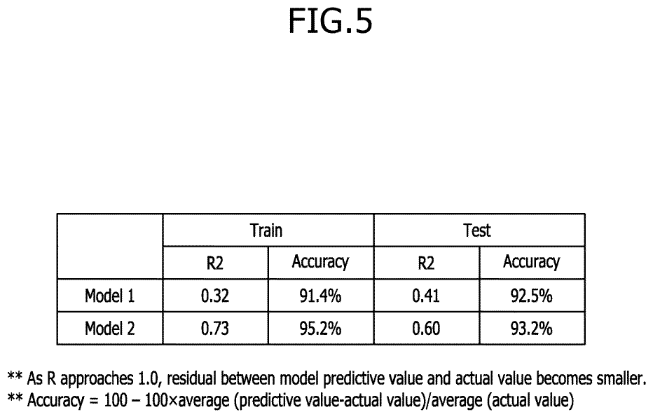

FIG. 5 illustrates prediction accuracy of a first model and a second model with respect to viscosity of a slurry according to an embodiment.

Referring to FIG. 5, a first model having an accuracy of 92.5% is generated through machine learning, two topmost factors is calculated from the first model, and a second model is generated through preprocessing of the two topmost factors for each mixing step. The second model produces improved slurry viscosity prediction results with an accuracy of 93% and a residual of 0.6, as compared with the first model.

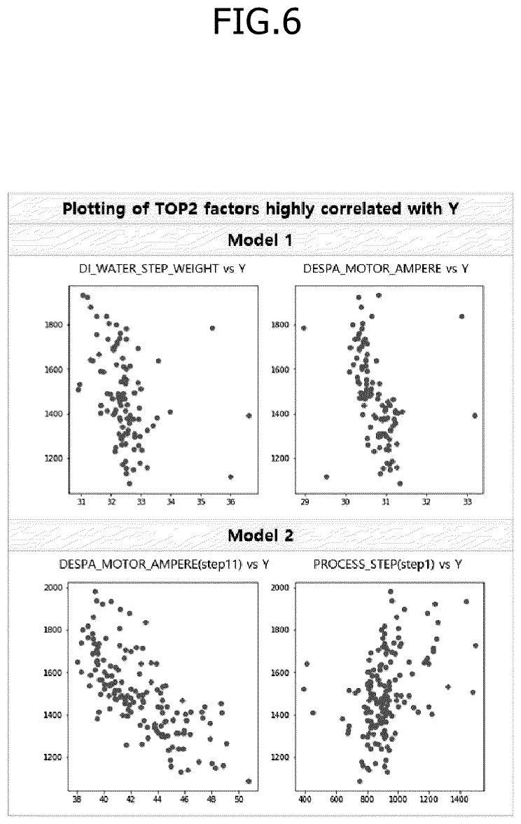

FIG. 6 illustrates test results of factors identified to be highly correlated with a final actual viscosity Y from a first model and a second model according to an embodiment.

Referring to FIG. 6, from the first model, two factors, e.g., DI_WATER_STEP_WEIGHT and DESPA_MOTOR_AMPERE, were identified to be highly correlated with the final actual viscosity and, from the second model, DESPA_MOTOR_AMPERE (step 11) and PROCESS_STEP (step 1) were identified to be highly correlated with the final actual viscosity based on results of analysis of correlation between viscosity of a slurry and the two topmost factors identified from the first model for each mixing step.

Without the present method, viscosity of a slurry prepared by conventional methods is required to meet prescribed specifications due to effects thereof not only on operation of the mixing process but also on the quality of subsequent processes. In order to determine the viscosity of a slurry made by conventional methods, the slurry is sampled immediately after the mixing process, followed by measurement of the viscosity of the slurry using a separate viscometer. If the measured viscosity of the slurry is out of specification, the viscosity of the slurry is controlled by changing conditions of the mixing process. This trial and error, back and forth method is inefficient and suffers from serious drawbacks. One drawback with a sampling type slurry viscosity measurement method is that viscosity of a slurry can change during preparation for measurement and an additional complicated process, such as manual sampling by an operator using a separate measuring instrument, is required. Moreover, these changes and complications incur additional consumption of resources, such as manpower, equipment and time.

Therefore, there is a need for technology that can achieve slurry viscosity meeting target specifications through real-time prediction of viscosity of a slurry while reducing errors in measurement of the viscosity of the slurry and eliminating the necessity of additional manual work and additional resource consumption.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. Therefore, the scope of the present invention should be defined by the appended claims. In addition, the embodiments described herein may be implemented, for example, as a method or process, a device, a software program, a data stream, or a signal. Although discussed in the context of a single type of implementation (for example, discussed only as a method), features discussed herein may also be implemented in other forms (for example, a device or a program). The device may be implemented by suitable hardware, software, firmware, and the like. The method may be implemented on a device, such as a processor that generally refers to a processing device including a computer, a microprocessor, an integrated circuit, a programmable logic device, etc. The processor includes a communication device such as a computer, a cell phone, a personal digital assistant (PDA), and other devices that facilitate communication of information between the device and end-users.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An apparatus for controlling viscosity of a slurry, comprising:
a mixing module mixing raw materials for a secondary battery; and
a processor performing machine learning for prediction of viscosity of the slurry, predicting viscosity of the slurry in real time during a mixing process through machine learning, and adjusting conditions of the mixing process performed by the mixing module such that a predictive viscosity of the slurry meets a target viscosity.

2. The apparatus as claimed in claim 1, wherein the processor extracts at least one mixing process datum highly correlated with viscosity of the slurry from multiple mixing process data through machine learning and performs prediction of viscosity of the slurry based on the at least one mixing process datum.

3. The apparatus as claimed in claim 1, wherein the processor generates a first model through training with N mixing process data and N final actual viscosity data using a predetermined algorithm, the first model being a model for extraction of mixing process data highly correlated with a final viscosity of the slurry and prediction of viscosity of the slurry.

4. The apparatus as claimed in claim 1, wherein the processor identifies at least one topmost factor highly correlated with a final actual viscosity using a first model, calculates multiple top factor data through preprocessing of the identified topmost factor for each mixing step, and generates a second model through training with the multiple top factor data calculated for each mixing step and final actual viscosity data using a predetermined algorithm, the second model being a model for extraction of mixing process data highly correlated with a final viscosity of the slurry and prediction of viscosity of the slurry.

5. The apparatus as claimed in claim 4, wherein:
the processor checks prediction accuracy of the second model; and
if the prediction accuracy of the second model is greater than or equal to a predetermined rate, the processor retrains or updates the second model each time new data is generated and, if the prediction accuracy of the second model is less than the predetermined rate, the processor changes the algorithm.

6. The apparatus as claimed in claim 1, wherein the processor controls the mixing module by:
calculating a final predictive viscosity by inputting mixing process data to a second model upon start of mixing;
calculating a new final predictive viscosity by changing settings of mixing process data identified to be highly correlated with a final actual viscosity of the slurry from a first model and the second model and inputting the mixing process data changed due to change of the settings to the second model, if the final predictive viscosity does not meet the target viscosity; and
calculating settings of mixing process factors ensuring that the final predictive viscosity meets the target viscosity by repeating a procedure of changing settings of mixing process data and calculating a final predictive viscosity until the final predictive viscosity meets the target viscosity.

7. A method for controlling viscosity of a slurry, comprising:
controlling, by a processor, a mixing module to mix raw materials for a secondary battery;
performing, by the processer, machine learning for prediction of viscosity of the slurry and predicting viscosity of the slurry in real time during a mixing process through machine learning; and
adjusting, by the processor, conditions of the mixing process performed by the mixing module such that a predictive viscosity of the slurry meets a target viscosity.

8. The method as claimed in claim 7, wherein, in the step of predicting viscosity of the slurry in real time, the processor extracts at least one mixing process datum highly correlated with viscosity of the slurry from multiple mixing process data through machine learning and performs prediction of viscosity of the slurry based on the at least one mixing process datum.

9. The method as claimed in claim 7, wherein, in order to predict viscosity of the slurry in real time, the processor generates a first model through training with N mixing process data and N final actual viscosity data using a predetermined algorithm, the first model being a model for extraction of mixing process data highly correlated with a final viscosity of the slurry and prediction of viscosity of the slurry.

10. The method as claimed in claim 7, wherein, in order to predict viscosity of the slurry in real time, the processor identifies at least one topmost factor highly correlated with a final actual viscosity using a first model, calculates multiple top factor data through preprocessing of the identified topmost factor for each mixing step, and generates a second model through training with the multiple top factor data calculated for each mixing step and final actual viscosity data using a predetermined algorithm, the second model being a model for extraction of mixing process data highly correlated with a final viscosity of the slurry and prediction of viscosity of the slurry.

11. The method as claimed in claim 10, wherein:
the processor checks prediction accuracy of the second model; and,
if the prediction accuracy of the second model is greater than or equal to a predetermined rate, the processor retrains or updates the second model each time new data is generated and, if the prediction accuracy of the second model is less than the predetermined rate, the processor changes the algorithm.

12. The method as claimed in claim 7, wherein in the step of adjusting conditions of the mixing process performed by the mixing module, the processor controls the mixing module by:
calculating a final predictive viscosity by inputting mixing process data to a second model upon start of mixing;
calculating a new final predictive viscosity by changing settings of mixing process data identified to be highly correlated with a final actual viscosity of the slurry from a first model and the second model and inputting the mixing process data changed due to change of the settings back to the second model, if the final predictive viscosity does not meet the target viscosity; and
calculating settings of mixing process factors ensuring that the final predictive viscosity meets the target viscosity by repeating a procedure of changing settings of mixing process data and calculating a final predictive viscosity until the final predictive viscosity meets the target viscosity.
